(19) United States
(12) Patent Application Publication
(10) Pub. No.: US 2017/0038780 A1
(43) Pub. Date: Feb. 9, 2017

(54) METHOD OF DRONE DELIVERY USING AIRCRAFT

(71) Applicant: Gerald N. Fandetti, Cambridge, MA (US)

(72) Inventor: Gerald N. Fandetti, Cambridge, MA (US)

(21) Appl. No.: 14/817,356

(22) Filed: Aug. 4, 2015

(51) Int. Cl. G05D 1/10; B64D 1/02; B64D 5/00; B64C 39/02; B64B 1/22

(52) U.S. Cl. CPC G05D 1/104; B64C 39/02; B64B 1/22; B64D 5/00; B64D 1/02; B64C 2201/082; B64C 2201/128

(57) ABSTRACT

A drone delivery method is provided. The present invention includes an aircraft having a cargo area. The cargo area may include at least one package and at least one unmanned aerial vehicle (UAV). The aircraft flies to a location. The aircraft then releases the UAV from the cargo area while the aircraft is flying or hovering. The package is secured to the UAV prior to releasing the UAV from the cargo area. The UAV is then directed to a delivery destination. Once the UAV has reached the delivery destination, the package is released for delivery. Once the package has been released, the UAV may be directed back to the cargo area within the aircraft.

### BACKGROUND OF THE INVENTION

The present invention relates to drone delivery and, more particularly, to a method of drone delivery using manned aircraft.

Package delivery or parcel delivery is the delivery of shipping containers, parcels, or high value mail as single shipments. The service is provided by most postal systems, express mail, private package delivery services, and less than truckload shipping carriers. A delivery drone, also known as a parcelcopter, is an unmanned aerial vehicle (UAV) utilized to transport packages, food or other goods. In the United States initial attempts at commercial use of UAVs were blocked by FAA regulation. Drone delivery today faces significant problems concerning package weight, FAA restrictions, and distances to a customer.

As can be seen, there is a need for a drone delivery that is safe and effective.

### SUMMARY OF THE INVENTION

In one aspect of the present invention, a method of drone delivery comprises the steps of: providing an aircraft comprising a cargo area containing at least one package and at least one unmanned aerial vehicle; flying the aircraft to a location; and releasing the at least one unmanned aerial vehicle from the cargo area while the aircraft is flying or hovering, wherein the at least one package is secured to the at least one unmanned aerial vehicle.

In another aspect of the present invention, a method of drone delivery comprising the steps of: providing an aircraft comprising a cargo area containing at least one package and at least one unmanned aerial vehicle; flying the aircraft to a location; releasing the at least one unmanned aerial vehicle from the cargo area while the aircraft is flying or hovering, wherein the at least one package is secured to the at least one unmanned aerial vehicle; directing the at least one unmanned aerial vehicle to a delivery destination; and releasing the package from the unmanned aerial vehicle at the delivery destination.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention; and

FIG. 2 is a flow chart outlining method steps of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a method for delivering small packages using drones. The small packages and the drones may first be loaded onto a cargo area of an aircraft. The number may be determined by weather conditions, distance to be delivered, and capacity of the airship cargo bay. The aircraft may then fly to a location where several package delivery drones could be released and may hover in the location until all packages are delivered and drones are returned to the cargo bay of the airship. A drone operator can control the drones visually for safety and accuracy of delivery. Since the drone is flying a relatively short distance it can carry a heavier payload and is working with gravity going down which does not require as much power.

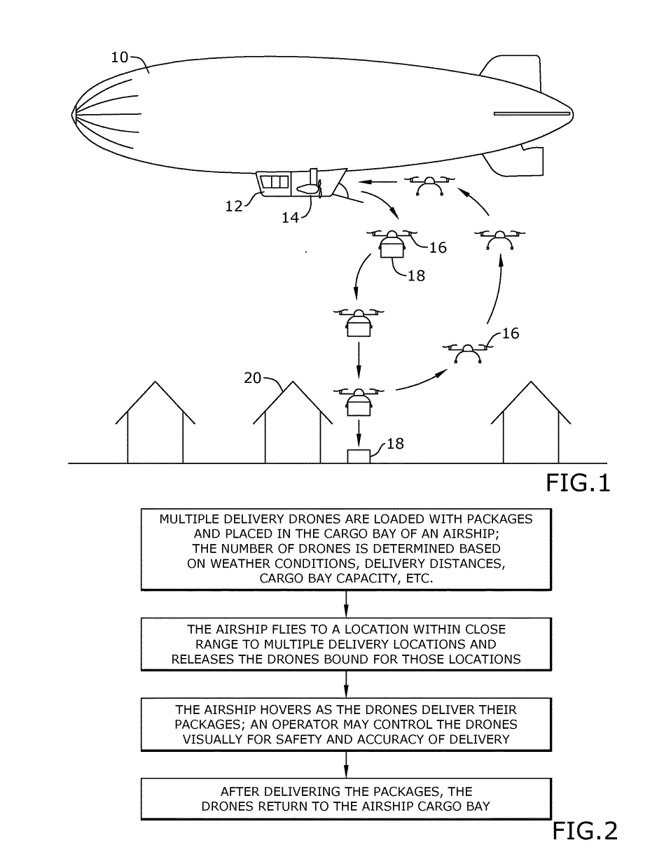

Referring to FIGS. 1 and 2, the present invention includes a drone delivery method. The present invention includes an aircraft 10 having a cargo area 14. The cargo area 14 may include at least one package 18 and at least one unmanned aerial vehicle (UAV) 16. The aircraft 10 flies to a location. The aircraft 10 then releases the UAV 16 from the cargo area 14 while the aircraft 10 is flying or hovering. The package 18 is secured to the UAV 16 prior to releasing the UAV 16 from the cargo area 14. The UAV 16 is then directed to a delivery destination 20. Once the UAV 16 has reached the delivery destination 20, the package 18 is released for delivery. Once the package 18 has been released, the UAV 16 may be directed back to the cargo area 14 within the aircraft 10.

In certain embodiments, the aircraft 10 of the present invention may include a lighter than air aircraft such as a blimp. However, the aircraft 10 is not limited to a blimp, and may include a hot air balloon, a zeppelin, a plane, helicopter and the like. The blimp of the present invention may include a control gondola 12. The control gondola 12 may include a cockpit in which users may fly the blimp. The control gondola 12 may also include the cargo area 14. The control gondola 12 may include a pivoting door which may open and close, providing the UAVs 16 with an exit from the cargo area 14 during the releasing and retrieval step. Therefore, once the location has been reached by the aircraft, the door may pivot open, and the UAVs 16 may be released. Once the UAVs 16 have delivered the package 18, the UAV may return to the cargo area 14 through the opened door.

The present invention may be used for the delivery of small packages 18. In such embodiments, the cargo area 14 may be loaded with a plurality of packages 18 prior to the aircraft 10 taking off from the ground. The aircraft 10 may fly to a plurality of different locations. Each location may be in close proximity to one or more delivery destinations. In certain embodiments, if there is more than one delivery destination per location, the present invention may utilize a plurality of UAVs 16. For example, once the aircraft 10 has reached a first location, a plurality of UAVs 16 may be released from the cargo area 14. The aircraft 10 may remain in the location for a period of time until delivery and retrieve the UAV 16 once delivery has been complete. Each UAV 16 may deliver a package 18 at a different delivery destination. The delivery destinations may be buildings such as homes or businesses. The plurality of UAVs 16 may then return to the cargo area 14 and the aircraft 10 may fly to the next location in which the above steps are repeated.

It should be understood, of course, that the foregoing relates to exemplary embodiments of the invention and that modifications may be made without departing from the spirit and scope of the invention as set forth in the following claims.

What is claimed is:

1. A method of drone delivery comprising the steps of:
providing an aircraft comprising a cargo area containing at least one package and at least one unmanned aerial vehicle;
flying the aircraft to a location; and
releasing the at least one unmanned aerial vehicle from the cargo area while the aircraft is flying or hovering, wherein the at least one package is secured to the at least one unmanned aerial vehicle.

2. The method of claim 1, further comprising the step of directing the at least one unmanned aerial vehicle to a delivery destination.

3. The method of claim 2, further comprising the step of releasing the package from the unmanned aerial vehicle at the delivery destination.

4. The method of claim 3, further comprising the step of directing the unmanned aerial vehicle back to the cargo area after the step of releasing the package.

5. The method of claim 1, wherein the aircraft is a blimp comprising a control gondola.

6. The method of claim 2, wherein the cargo area is within the control gondola.

7. The method of claim 1, wherein the at least one package comprises a plurality of packages.

8. The method of claim 4, wherein the at least one unmanned aerial vehicle comprises a plurality of unmanned aerial vehicles.

9. A method of drone delivery comprising the steps of:
providing an aircraft comprising a cargo area containing at least one package and at least one unmanned aerial vehicle;
flying the aircraft to a location;
releasing the at least one unmanned aerial vehicle from the cargo area while the aircraft is flying or hovering in the air, wherein the at least one package is secured to the at least one unmanned aerial vehicle;
directing the at least one unmanned aerial vehicle to a delivery destination; and
releasing the package from the unmanned aerial vehicle at the delivery destination.

10. The method of claim 9, further comprising the step of directing the unmanned aerial vehicle back to the cargo area after the step of releasing the package.
